(19) United States
(12) Patent Application Publication
(10) Pub. No.: US 2010/0085964 A1
(43) Pub. Date: Apr. 8, 2010

(54) COMMUNICATIONS SYSTEM AND METHOD

(76) Inventors: Alexander Weir, Edinburgh (GB); Mark Norris, Cambridge (GB)

Correspondence Address: REED SMITH LLP, P.O. BOX 488, PITTSBURGH, PA, 15230-0488, US

(21) Appl. No.: 12/438,345

(22) PCT Filed: Aug. 17, 2007
(86) PCT No.: PCT/GB07/03150

§ 371 Date: Nov. 24, 2009

(30) Foreign Application Priority Data
Aug. 22, 2006 (GB) 0616644.1

(51) Int. Cl. H04L 12/56

(52) U.S. Cl. 370/389; 375/260

(57) ABSTRACT

A method for transmitting data using data packets includes dividing a data portion of the data packet into two or more data segments, each having a corresponding check portion. The data packet may also be communicated over two or more logical communication channels. The order of data portions in one communication channel may differ from the order of data portions in a second communication channel. Identical or different check portions may be assigned to respective data portions.

### FIELD OF THE INVENTION

The present application relates to a communications system and method, and in particular to a packet-based communications system and method, for example an ultra-wideband communications system and method.

### BACKGROUND OF THE INVENTION

Ultra-wideband is a radio technology that transmits digital data across a very wide frequency range, 3.1 to 10.6 GHz. By spreading the RF energy across a large bandwidth the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four band groups having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

Communication signals are transmitted in an ultra-wideband communications system between transmitter and receiver stations in the form of data packets. Each data packet includes a header portion, a data portion (or “payload”), and an error check portion, typically based on a cyclic redundancy check (CRC). The payload relates to the data to be sent from a transmitter to a receiver.

FIG. 2 of the accompanying drawings shows, for illustration only, a simple wireless communications system 20 in which a transmitter 22 transmits signals to a receiver 24. In many systems, multiple channels 26, 27 are used for transmission between the transmitter 22 and the receiver 24. In the context of UWB systems, and in particular MB-OFDM systems, physical channels are defined by Time Frequency Coding (TFC). Two methods of TFC are typically used: Time Frequency Interleaving (TFI) and Fixed Frequency Interleaving (FFI). In each of the band groups 1 to 4; (4x)TFI and (3x)FFI TFCs are used providing 7 physical channels per band group. The FFI technique is used in band group 5 and provides 2 additional physical channels. Therefore the MB-OFDM system shown in FIG. 1 will comprise 30 physical channels. In many wireless communications systems, multiple physical channels are used to transmit data in basic solutions for a simple user in order to minimize data loss.

In existing communication systems an incoming data packet is rejected if it contains any errors, so that the packet is lost and must be retransmitted. Accordingly, it is desirable to minimise the number of lost data packets in such a communications system, in order to improve quality of service of the system.

### SUMMARY OF THE INVENTION

Embodiments of the present invention provide a method for segmenting data packets and for reconstructing data packets from received segments. The data packet segments can be sent over respective channels of a communication system, and so the present invention can enable reconstruction of data packets even when data packet segments are in error.

According to one aspect of the present invention, there is provided a method for transmitting data comprising transmitting a data packet which includes a header portion, a data portion relating to data to be transmitted, and a packet check portion relating to the data portion, wherein the method comprises the steps of segmenting a data portion into first and second data segments, which relate to respective parts of the data portion, and providing first and second segment check portions relating to the first and second data segments respectively.

According to another aspect there is provided an apparatus for use in a communications system that transmits and/or receives a data packet which includes a header portion, a data portion relating to data to be transmitted, and a packet check portion relating to the data portion. The apparatus is adapted to transmit and/or receive a data portion comprising first and second data segments, which relate to respective parts of the data portion, and first and second segment check portions relating to the first and second data segments respectively.

### BRIEF DESCRIPTION OF THE DRAWINGS

For a better understanding of the present invention, and to show more clearly how it may be carried into effect, reference will now be made, by way of example only, to the accompanying drawings in which:

FIG. 1 shows the multi-band OFDM alliance (MBOA) approved frequency spectrum of a MB-OFDM system;

FIG. 2 is a schematic drawing of a communications system;

FIG. 3 illustrates a data packet for use in systems embodying the present invention;

FIG. 4 is a flow chart illustrating steps in a method embodying one aspect of the present invention; and

FIG. 5 illustrates a further example of data packets for use in systems embodying the present invention;

FIG. 6 illustrates a further example of data packets for use in systems embodying the present invention;

FIG. 7 illustrates a further example of data packets for use in systems embodying the present invention; and

FIG. 8 illustrates a further example of data packets for use in systems embodying the present invention.

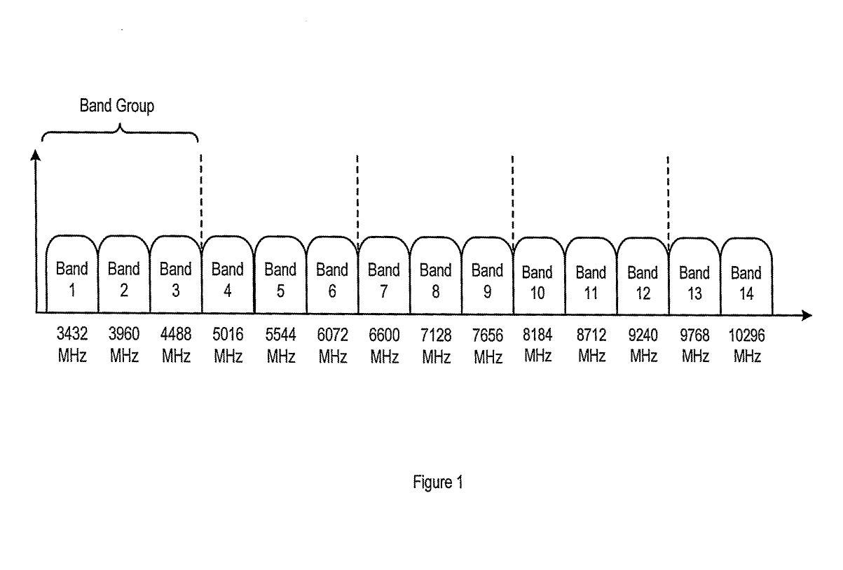

### DETAILED DESCRIPTION OF THE PREFERRED EMBODIMENTS

It is noted that the preferred embodiments described below are made in relation to an ultra-wideband communication system. However, the invention may also be used with other packet based communication systems.

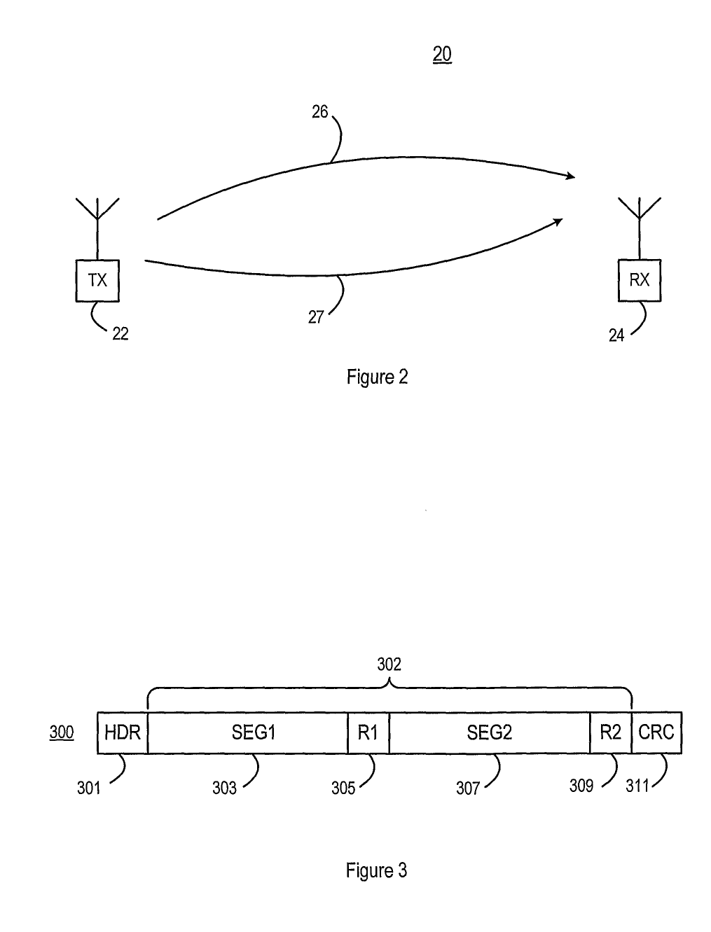

As described above, FIG. 2 illustrates an exemplary communications system for transmitting data packets from a transmitter 22 to receiver 24 over channels 26 and 27.

In the context of a UWB system, physical layer service data units (i.e. PHY service data units—PSDUs) are encoded and transmitted between devices over physical channels. Medium Access Controller service data units (i.e. MAC service data units—MDSUs) are transferred between MAC entities within PSDUs. Each MSDU has a delivery identification (Id) within its Frame control field in the MSDU header. The delivery Id is used to define a user priority (for asynchronous data transfer using a PCA scheme) or a Stream Index (for synchronous data transfer using a DRP scheme).

If the OSI layer model and the entity known as the Logical Link Controller (LLC) are considered, the MAC provides the data link layer over which the Logical Link Controller provides a multiplexed/de-multiplexed interface permitting multiple higher layer protocol entities access to the MAC MSDUs interface; based on the link QoS requirement.

The logical links (defined by stream indices) define the data path level of the packet data units (PDUs) discussed in the present invention. Thus, it will be appreciated that the present technique is not associated with data frame processing at the Data Link Layer (MAC) in the standard OSI reference model. Instead, the techniques described below are configured for use in layer 2 of the OSI reference model.

FIG. 3 illustrates a data packet structure in accordance with one aspect of the present invention, for example as received by a Data Link layer (MAC). The data packet 300 includes a header portion 301, a data portion (payload) 302, which relates to the data to be transmitted, and an error check portion (Cyclic Redundancy Check—CRC) 311.

In common with existing techniques, the header portion 301 incorporates information for the data packet so that it can be routed correctly through the communications system. The header portion 301 will also include information relating to the size of the data packet etc. The error check portion 311 contains suitable check digit data, such as a cyclic redundancy check, or other error correction data, in accordance with known techniques.

The data portion 302 in a data packet for use in an embodiment of the present invention comprises first and second data segments 303, 307 which contain the data to be transmitted from the transmitter to the receiver. The first and second data segments 303, 307 have respective associated segment check portions 305 and 309. The segment check portions incorporate check data for the segment concerned, which enable embodiments of the present invention to confirm the integrity of the associated data segment. Data integrity protection is provided for protecting against accidental alteration through transmission error due to poor channel characteristics, for example interference or signal quality. Differing CRC techniques provide differing implementation complexity (most commonly in digital hardware) and levels of protection. There are a number of industry defined techniques (e.g. CCITT CRC-16) as used for the protection of the PHY and MAC header in the HCS (see European Computer Manufacturer's Association standard ECMA-368). Other common data integrity techniques are CRC-7 and CRC-32 (as used in Ethernet). It will be appreciated that the invention can be used with any of these techniques, or indeed any combination of these techniques.

According to the embodiment shown in FIG. 3, the segment check portion 305 associated with the first data segment 303, i.e. R1, is different to the segment check portion 309 associated with the second data segment 307, i.e. R2. Alternatively, the first segment check portion 305 can be the same as the second segment check portion 309.

It will be readily appreciated that the data packets in accordance with the present invention may have more than two data segments and associated segment check portions. In addition, it will be appreciated that the lengths of the segments may be the same, or may vary from one segment to another.

The header portion 301 includes information regarding the number and length of the data segments.

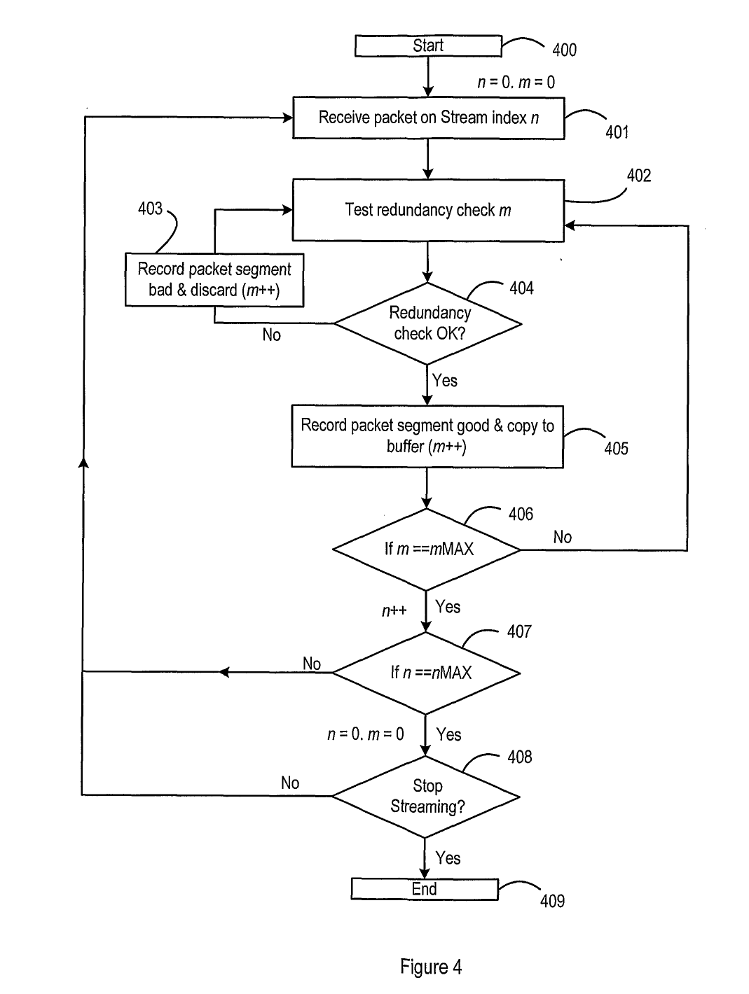

FIG. 4 illustrates steps in a method embodying one aspect of the present invention, which starts at step 400. At step 401 a data packet is received for channel “n”. The error check for the first segment of the received data packet is checked (step 402 and 404), and if the segment is found to be in error, the segment is discarded and the next segment checked. If, however, the error check for the first segment is found to be acceptable, then the first segment is stored, and the second segment is tested for errors (steps 405, 406). This process is repeated for all of the segments in the received data packet (step 406). Furthermore, the process is repeated for all of the channels available (steps 407, 408 and 409).

It will be appreciated that the technique described above provides a “protection diversity”, in which different error check algorithms can be used for each data packet segment. This results in different error check portions being transmitted in the data packet. When a good segment is received, the good segment can be stored and a re-transmission requested which is then matched with the good subsequently received packet. Alternatively, if there is sufficient bandwidth available, the packet can be transmitted over multiple MAC service data units (MSDUs), i.e. avoiding the need for a re-send, such that a good complete packet can be reconstructed by combining the good segment with the rest of the next good MSDU.

In isochronous applications, for example video streaming or audio streaming, it is possible to repeat the last good segment without throwing away the entire payload, provided that it is received only partially corrupted. It is also possible to decide to “blank” the bad segment (dependant on the number of prior bad segments and the application sensitivity). All of these techniques have the effect of reducing the perceived effect of interference or packet corruption to the user.

According to a further aspect of the invention, the segmentation technique described above is used in conjunction with multiple logical channels in order to improve the likelihood of error free data packet delivery, for example from a Data Link layer (MAC). In other words, in order to increase the possible protection, data in a data packet can be sent in two separate data packets, each data packet utilising a combination of segment check algorithms for the data segments therein. When using a segmented payload, as described above, it is then possible to incorporate other forms of protection and error correction in the technique, as will be described in greater detail below.

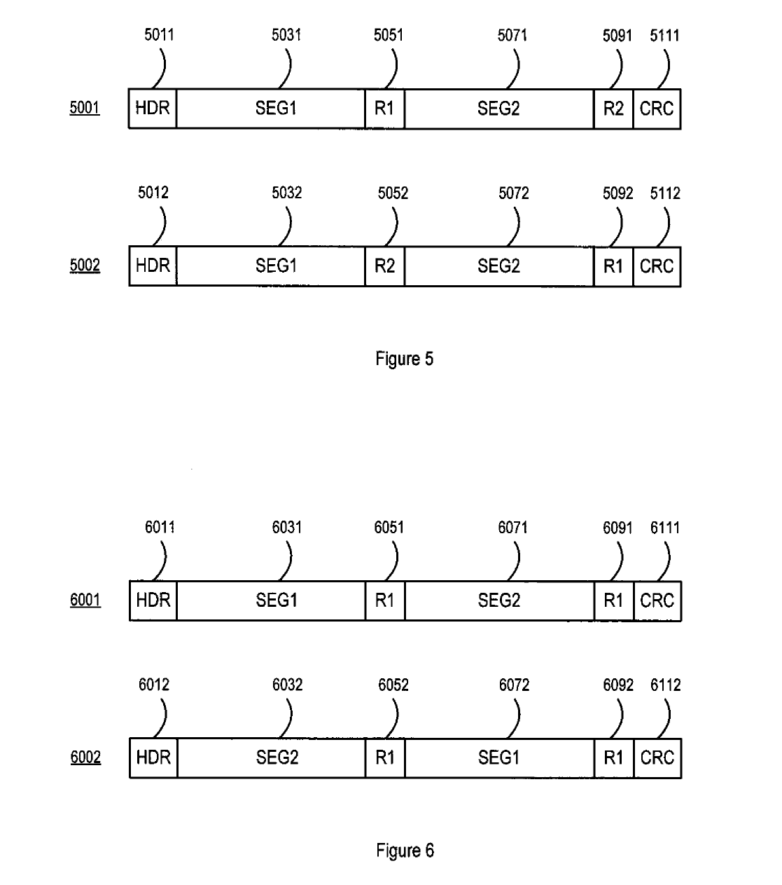

FIG. 5 illustrates one example in which a first packet 5001 has a header portion 5011, a first data segment 5031, a first segment check portion 5051, a second data segment 5071, a second segment check portion 5091, and a redundancy check portion 5111. A second data packet 5002 has similar header, data and error check portions. Each data packet transmits the first portion of data SEG1 before the second portion of data SEG2. However, in the illustrated example the arrangement of the segment check portions 5051, 5091 in the first packet 5001 differ from the arrangement of the segment check portions 5052 and 5092 in the second packet 5002 as follows.

In the first packet 5001 the segment check portion 5051 for the first data segment 5031 contains error check algorithm “R1”. However, in the second packet 5002 the segment check portion 5052 for the first data segment 5032 contains error check algorithm “R2”. Likewise, in the first packet 5001 the segment check portion 5091 for the second data segment 5071 contains error check algorithm “R2”, whereas in the second packet 5002 the segment check portion 5092 for the second data segment 5072 contains error check algorithm “R1”.

It will be appreciated that the manner in which the error check algorithms are interposed or swapped for the respective data segments will increase the likelihood of being able to recover an error-free packet at the receiver. This is because failure to detect the first data segment SEG1 in the first packet 5001 may be compensated by the ability to recover data SEG1 from the second data packet 5002, and similarly for the second data segment SEG2.

FIG. 6 shows a further example in which the two channels 6001 and 6002 differ by the order in which the data portions SEG1 and SEG2 are presented within the data packet. In the first data packet 6001 the data for the first data segment 6031 (i.e. SEG1) is presented before the data for the second data segment 6071 (i.e. SEG2). In contrast, in the second packet 6002, the second data segment SEG2 is presented in advance of the first data segment SEG1. In the illustrated example in FIG. 6, each of the segment check portions 6051, 6091, 6052, 6092 is shown to contain the same error check algorithm “R1”. It will be appreciated, however, that other combinations may also be used.

For example, segment check portions 6051 and 6092 could contain error check algorithm “R1” while segment check portions 6052 and 6091 contain error check algorithm “R2”, or vice versa. Alternatively, segment check portions 6051 and 6091 could contain error check algorithm “R1” while segment check portions 6052 and 6092 contain error check algorithm “R2”, or vice versa. Further combinations will also be possible, as appreciated by a person skilled in the art.

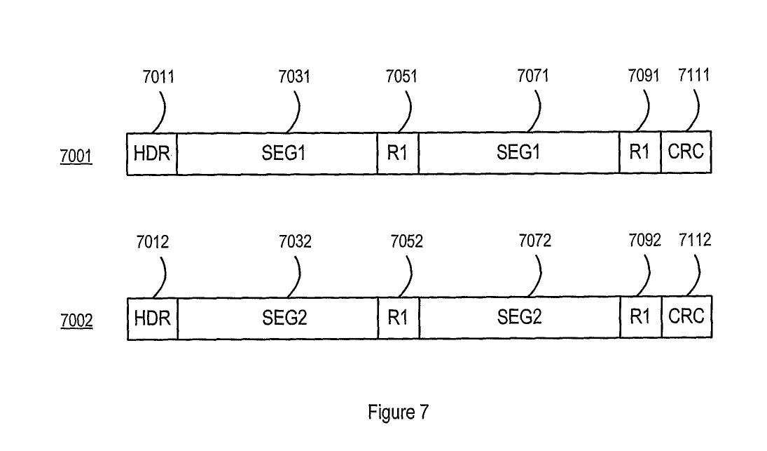

FIG. 7 illustrates a further example in which a first packet 7001 has a header portion 7011, a first data segment 7031, a first segment check portion 7051, a second data segment 7071, a second segment check portion 7091, and a redundancy check portion 7111. A second data packet 7002 has similar header, data and error check portions. The packets transmitted over the two channels 7001 and 7002 differ in that, in the first data packet 7001, the first portion of the data SEG1 is presented in the first data segment 7031 and the second data segment 7071, whereas the second packet 7002 contains the second portion of data SEG2 presented in its first data segment 7032 and second data segment 7072.

In the illustrated example in FIG. 7, each of the segment check portions 7051, 7091, 7052, 7092 is shown to contain the same error check algorithm “R1”. As above it will be appreciated, however, that other combinations may also be used. For example, segment check portions 7051 and 7092 could contain error check algorithm “R1” while segment check portions 7052 and 7091 contain error check algorithm “R2”, or vice versa. Alternatively, segment check portions 7051 and 7091 could contain error check algorithm “R1” while segment check portions 7052 and 7092 contain error check algorithm “R2”, or vice versa. Again, it will be appreciated that further combinations are also possible.

The data segment contents can therefore be found at different positions in the data packets received for the various logical channels. This once again increases the opportunity to obtain the data in an error free manner.

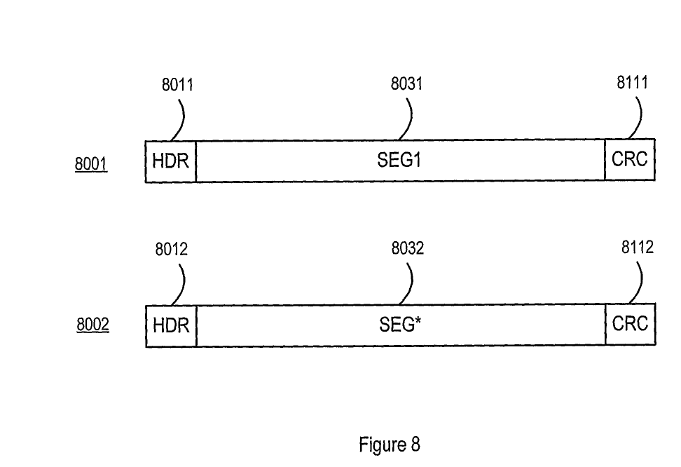

An enhancement to the time diversity techniques discussed above is to randomise the position of the segment data within the data portion of the data packet on each logical channel. For example, FIG. 8 shows a first packet 8001 having a header portion 8011, a data segment 8031 and a check portion 8111. A second packet 8002 contains a header portion 8012, a data segment 8032 and a check portion 8112. The data SEG1 in the data segment 8031 of the first packet 8001 differs from the data SEG1* in the data segment 8032 of the second packet 8002, such that the data SEG1* is randomized compared to the data in the first data segment 8031. In other words, the order of the data bits in SEG1* is changed compared to the order of the data bits in SEG1. With this embodiment an algorithm is required to recover the randomised order of the data from the received data packet. It will be appreciated that any one of a number of well known randomising techniques can be used in this aspect of the invention.

It will be appreciated that the invention described above provides improved data integrity and link resistance, thereby providing improved quality of service and higher tolerance to RF interference. The techniques described above are particularly advantageous in UWB communication systems which have significant transmit power restrictions, but not limited thereto.

The data packets according to the invention provide an improved data integrity and quality of service by allowing a receiver to select and rebuild error-free PDUs when all PDUs received over multiple logical channel may contain errors.

In addition to providing an improved method of transmitting packet data, the invention also provides an improved apparatus for use in a communications system.

As described above, the techniques described in relation to the preferred embodiment are intended for use at the layer 2 level of the OSI layer model.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim and “a” or “an” does not exclude a plurality. Any reference signs in the claims shall not be construed so as to limit their scope.

1. A method for transmitting data comprising transmitting a data packet which includes a header portion, a data portion relating to data to be transmitted, and a packet check portion relating to the data portion, wherein the method comprises the steps of:
segmenting the data portion into first and second data segments, which relate to respective parts of the data portion; and
providing first and second segment check portions relating to the first and second data segments respectively.

2. A method as claimed in claim 1, wherein the first and second segment check portions are generated in dependence upon the contents of the first and second data segments respectively.

3. A method as claimed in claim 2, wherein the first and second segment check portions are generated using respective first and second error check algorithms.

4. A method as claimed in claim 3, wherein the first and second algorithms differ.

5. A method as claimed in claim 3, wherein the first and second algorithms are substantially identical.

6. A method as claimed in claim 1, wherein the data carried by the data packet is transmitted over multiple communication channels.

7. A method as claimed in claim 6, wherein the order of the data segments to be transmitted in the data packets concerned varies between communication channels.

8. A method as claimed in claim 7, wherein the order of the data within the data packet is randomised.

9. A method as claimed in claim 6, further comprising the step of reconstructing a data portion using first and second data segments from first and second channels.

10. A method as claimed in claim 1, further comprising the step of reconstructing a data portion using a first data segment from an initial transmission step, and a second data segment from a re-transmission step.

11. A method as claimed in claim 1, wherein the method steps relate to the layer two level of the OSI layer model.

12. An apparatus for use in a communications system that transmits and/or receives a data packet which includes a header portion, a data portion relating to data to be transmitted, and a packet check portion relating to the data portion, wherein the apparatus is adapted to transmit and/or receive a data portion comprising first and second data segments, which relate to respective parts of the data portion, and first and second segment check portions relating to the first and second data segments respectively.

13. An apparatus as claimed in claim 12, further comprising means for generating the first and second segment check portions in dependence upon the contents of the first and second data segments respectively.

14. An apparatus as claimed in claim 13, wherein the means for generating the first and second segment check portions comprises means for generating respective first and second error check algorithms.

15. An apparatus as claimed in claim 14, wherein the means for generating the first and second segment check portions is adapted to generate first and second error check algorithms that differ.

16. An apparatus as claimed in claim 14, wherein the means for generating the first and second segment check portions is adapted to generate first and second error check algorithms that are substantially identical.

17. An apparatus as claimed in claim 12, wherein the data carried by the data packet is transmitted over multiple communication channels.

18. An apparatus as claimed in claim 17, wherein the order of the data segments to be transmitted in the data packets concerned varies between communication channels.

19. An apparatus as claimed in claim 18, further comprising means for randomising the order of the data within each data segment of the data packet.

20. An apparatus as claimed in claim 17, further comprising means for reconstructing a data portion using first and second data segments from first and second channels.

21. An apparatus as claimed in claim 12, further comprising means for reconstructing a data portion using a first data segment from an initial transmission step, and a second data segment from a re-transmission step.
